(19) United States
(12) Patent Application Publication
(10) Pub. No.: US 2021/0373391 A1
(43) Pub. Date: Dec. 2, 2021

(54) U-SHAPED UNIT AND LIQUID CRYSTAL ELEMENT WITH U-SHAPED COPLANAR ELECTRODE UNITS

(71) Applicant: Tunghai University, Taichung City (TW)

(72) Inventors: Chia-Yi Huang, Taichung City (TW); Wei-Fan Chiang, Taichung City (TW); Yi-Hong Shih, Taichung City (TW); Yan-Shou Lin, Taichung City (TW)

(21) Appl. No.: 17/322,290

(22) Filed: May 17, 2021

(30) Foreign Application Priority Data
May 28, 2020 (TW) 109117945

(51) Int. Cl. G02F 1/1343

(52) U.S. Cl. CPC G02F 1/134363; G02F 1/13439

(57) ABSTRACT

A U-shaped unit and a liquid crystal element with U-shaped coplanar electrode units provided by the invention are capable of increasing a horizontal electric field intensity in a power supply state, so that when the invention is applied to be used as a liquid crystal driving element, a required horizontal electric field intensity can be achieved with a lower driving voltage to reduce a required driving power when the liquid crystal element is used as a display screen, thereby achieving an effect of power saving.

### BACKGROUND OF THE INVENTION

### Field of Invention

The invention is related to electric field technology, and more particularly to a U-shaped coplanar electrode unit capable of increasing a horizontal electric field intensity.

### Related Art

The technical means of using electric field to control the alignment of liquid crystal molecules and change the refraction angle of backlight in order to achieve color conversion is a well-known principle of liquid crystal display devices. Different liquid crystal display technologies developed on this basis are still being disclosed in recent years. Disclosed alignment technologies for forming an appropriate electric field between the two baseplates filled with liquid crystal include multi-domain vertical alignment (MVA) in which electrodes are provided on both sides of the liquid crystal layer to form an electric field between the two electrodes after electric power is supplied; in-plane-switching (IPS) in which an electrode is disposed on one side of the liquid crystal layer to form an electric field above the electrode after electric power is supplied; as well as other alignment technologies developed based on the above alignment technologies, for example, A-MVA, FSS, etc.

With the development of technologies, the control of liquid crystals is no longer just a mere alignment to achieve the object of changing colors. In the increasingly sophisticated technological development, current display technologies are developed in a direction towards obtaining effects of wider viewing angle, shorter response time, and better color contrast.

However, while further improving the liquid crystal display technology, the conventional technology has not been able to effectively reduce the driving voltage of liquid crystal alignment, especially in the technical field of using IPS. As shown in an electric field of IPS in FIG. 1, a parabolic electric field is formed above a pixel electrode 1 and common electrodes 2, under this form of electric field, the transverse component formed in the horizontal direction is limited, and it is difficult to form electric field in the vertical direction positions of the electrodes 1, 2, and therefore the intensity of the horizontal electric field formed is limited. In order to increase the intensity of the horizontal electric field, the conventional technology can only achieved it by increasing the driving voltage. However, it causes a drawback of excessively high driving voltage. As a result, in order to drive the liquid crystal for display, it is necessary to consume more electric power energy, which makes the screen display element the most power-consuming component in a smart phone.

### SUMMARY OF THE INVENTION

Therefore, a main object of the invention is to provide a U-shaped unit capable of increasing an aspect ratio of side portions with free ends on two sides of the U-shape in order to improve effects produced by the U-shaped unit in industrial applications by the side portions with high aspect ratio, such as increasing a horizontal electric field intensity, increasing a heat dissipation surface area or used as unit integration of an optical element, wherein, in the effect of increasing the horizontal electric field intensity, the U-shaped unit can be used as a constituent unit of an electrode element to be served as a U-shaped coplanar electrode unit, thereby increasing the horizontal electric field intensity under electric power supply state, so that when the U-shaped unit is applied to be used as a liquid crystal driving element, a required horizontal electric field intensity can be achieved with a lower driving voltage to reduce a required driving power when the liquid crystal element is used as a display screen, thereby achieving an effect of power saving.

In order to achieve the above object, the U-shaped coplanar electrode unit provided by the invention makes the electrode unit generally U-shaped, and has a base corresponding to a U-shaped closed end position, and two side portions corresponding to two side positions of the U-shape, and a ratio between a thickness and a height of each of the side portions is between 1:20 and 1:2, so that two side planes of each of the side portions parallel to the height direction can be used as electrode planes.

In the U-shaped coplanar electrode unit, the electrode unit can be miniaturized to be used as an electrode of a liquid crystal display element, when the U-shaped coplanar electrode unit is used as the electrode of the liquid crystal display element, in addition to disposing a plurality of electrode units on a same side of a liquid crystal layer, the electrode units can also be disposed on different sides of the liquid crystal layer.

Wherein, when the electrode units are disposed on different sides of the liquid crystal layer, U-shaped openings of the electrode units on the different sides are facing each other in a staggered manner, so that a single side portion of each of the electrode units on one of the sides and a single side portion of each of the electrode units on the other side are inserted into the U-shaped opening of each other, and the electrode units on the different sides are arranged in a staggered manner.

Another object of the invention is to provide a unit structure with a high aspect ratio, which has a base and side portions extending from two sides of the base in a same direction outwardly along a predetermined angle direction, and a ratio between a thickness and a height of each of the side portions is between 1:2 and 1:20. A high and narrow shape of each of the side portions is provided as a component in the field of microelectronic technology, for example, as the aforementioned electrode unit or as a heat dissipation unit of a heat dissipation element.

### BRIEF DESCRIPTION OF THE DRAWINGS

FIG. 1 is a plan view of the conventional in-plane-switching (IPS) technology;

FIG. 2 is a plan view of a first preferred embodiment of the invention;

FIG. 3 is a partial plan view of a second preferred embodiment of the invention;

FIG. 4 is a voltage-transmittance graph of using a positive type liquid crystal as a liquid crystal layer in the second preferred embodiment of the invention;

FIG. 5 is a voltage-transmittance graph of using a blue phase liquid crystal as a liquid crystal layer in the second preferred embodiment of the invention;

FIG. 6 is a partial plan view of a third preferred embodiment of the invention;

FIG. 7 is a voltage-transmittance graph of using a positive type liquid crystal as a liquid crystal layer in the third preferred embodiment of the invention; and

FIG. 8 is a voltage-transmittance graph of using a blue phase liquid crystal as a liquid crystal layer in the third preferred embodiment of the invention.

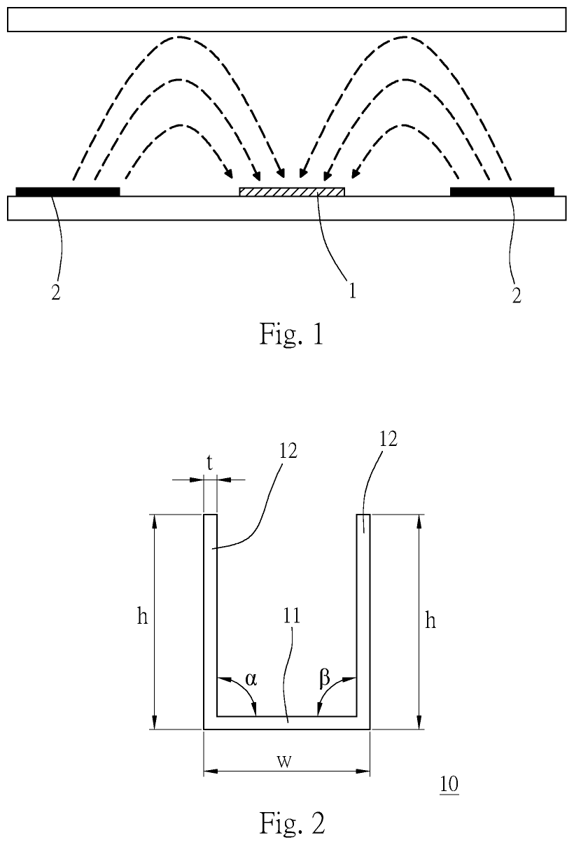

### DETAILED DESCRIPTION OF THE INVENTION

In order to enable the examiner to further understand the objects, features, and achieved efficacies of the invention, three preferred embodiments are described below for detailed explanation in conjunction with the drawings.

First of all, please refer to FIG. 2. A U-shaped coplanar electrode unit 10 provided in a first preferred embodiment of the invention comprises a strip-shaped base 11 and two strip-shaped side portions 12 respectively disposed on two sides of the base 11.

In terms of shape, the electrode unit 10 is in a U-shape with the base 11 as a bottom and each of the side portions 12 as a wall, wherein although included angles α, β between each of the side portions 12 and the base 11 are shown as an included angle of 90 degrees in the figure, the included angles are not limited thereto, an angular degree of the included angle is any value between 45 degrees and 135 degrees, also, it is not necessary to make the included angle between each of the side portions 12 and the base 11 the same. It should be emphasized here that the base 11 is used as a basis, and a height of each of the side portions 12 being formed can be increased, so that a ratio between a height and a thickness of each of the side portions 12 can be expanded to 20:1, thereby increasing an action range of each of the side portions 12, so that the electrode unit 10 is capable of producing efficacy better than the conventional technologies.

In terms of dimension, a width w of the base 11 between two ends of its strip-shape is between 3 nm and 20 μm. A height h is measured from one end of each of the side portions 12 connected with the base 11 to a free end of each of the side portions 12, a thickness t is a dimension of each of the side portions 12 parallel to a direction of the width w, and a ratio between the thickness t and the height h is preferably between 1:20 and 1:2. Specifically, the height h of each of the side portions 12 is between 3 nm and 20 μm, and the thickness t of each of the side portions 12 is between 3 nm and 2 μm.

In terms of material, constituent elements of the electrode unit 10 can be made of a same material or different materials, depending on requirements of an actual product, transparent conductive material, metal material, dielectric material or semiconductor material can be used to make the electrode unit 10. The transparent conductive material can be, for example, indium tin oxide, indium zinc oxide, indium gallium zinc oxide, indium tin zinc oxide, aluminum tin oxide, aluminum zinc oxide, cadmium tin oxide or cadmium zinc oxide. The metal material can be gold, silver, copper, iron, aluminum, platinum, titanium, indium, molybdenum, tin, manganese or zinc. The dielectric material can be titanium dioxide, silicon dioxide, silicon nitride, silicon oxide, nitrides of silicon, calcium titanate, magnesium titanate, barium titanate or composite oxides. The semiconductor material can be aluminum gallium nitride, aluminum nitride (indium) gallium, gallium arsenide, gallium phosphide or indium antimonide. Selection of materials is general knowledge to those having ordinary skill in the art to which the invention pertains, selection can be made according to the ordinary skill at the time of application of the invention, and according to requirements of a product to which the electrode unit 10 is applied, the materials are only provided as examples by the invention, and types of the materials should not be used as limiting conditions to limit the scope of the claims of the invention.

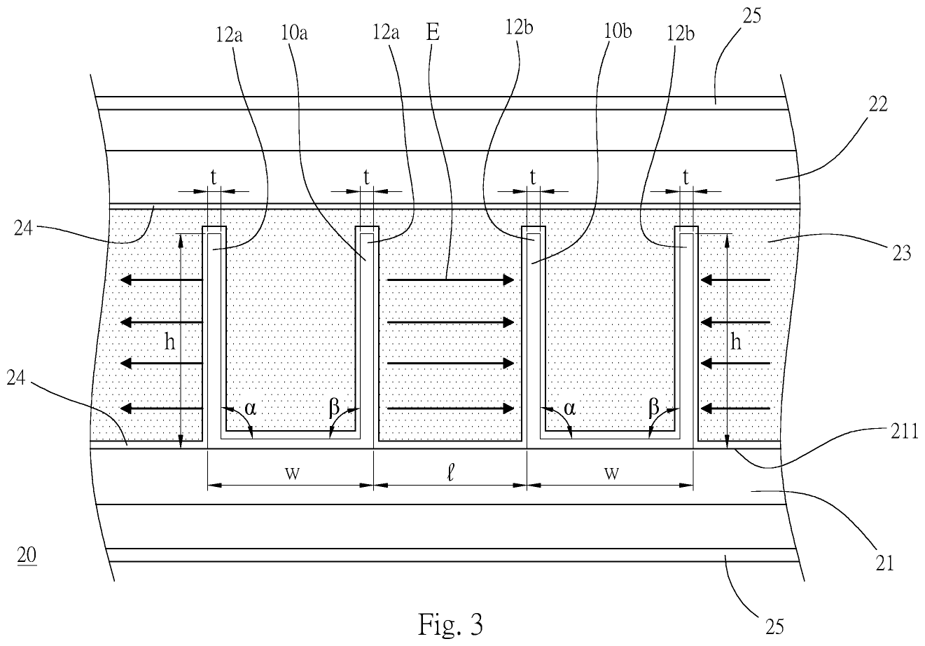

Please refer to FIG. 3. A second preferred embodiment of the invention is a specific application example of the electrode unit 10 disclosed in the first preferred embodiment, and the electrode units 10 are respectively used as common electrodes 10a and pixel electrodes 10b of a liquid crystal element 20.

The liquid crystal element 20 mainly comprises a first baseplate 21, a second baseplate 22 separated from the first baseplate 21 with a spacing of 1 μm to 25 μm, and a liquid crystal layer 23 sealed between the first baseplate 21 and the second baseplate 22, wherein the liquid crystal layer 23 is made of positive type liquid crystal material in this embodiment, but it is not limited thereto in specific implementation, the liquid crystal layer 23 can also be negative type liquid crystal, ferroelectric liquid crystal, polymer dispersed liquid crystal, polymer stabilized liquid crystal or blue phase liquid crystal. In addition, the liquid crystal element 20 further comprises alignment films 24 respectively located on two sides of the liquid crystal layer 23, and polarizers 25 respectively located on outer sides of the first baseplate 21 and the second baseplate 22, which are contents of the conventional technologies that will not be described herein.

In this embodiment, each of the electrode units 10 is disposed on a same side of the liquid crystal layer 23, that is, on a side 211 of the first baseplate 21 facing the second baseplate 22 as shown in FIG. 3. According to requirements of alignment technology, a part of each of the electrode units 10 is used as the common electrode 10a, another part of each of the electrode units 10 is used as the pixel electrode 10b, and an interval 1 spaced between the common electrode 10a and the pixel electrode 10b adjacent to each other is between 3 nm and 20 μm.

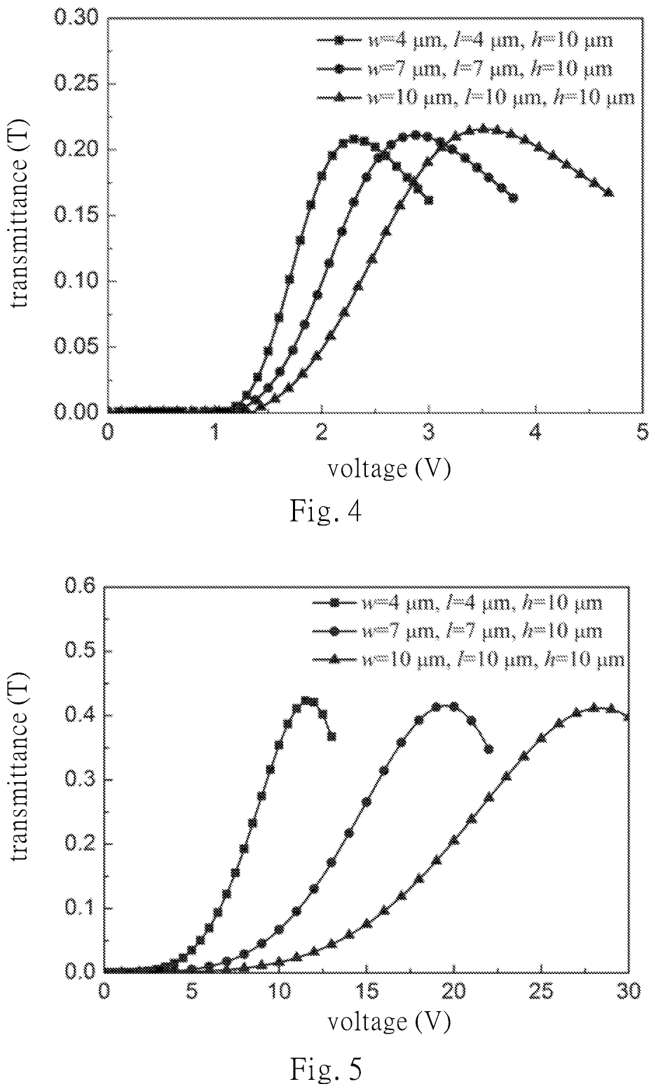

Thereby, after voltage is supplied, a horizontal electric field E can be formed between the common electrode 10a and the pixel electrode 10b, and at the same time, the height h of each of side portions 12a, 12b is greater than half of a distance between the first baseplate 21 and the second baseplate 22, so that a range of the horizontal electric field E formed is capable of reaching the entire liquid crystal layer 23; thereby, a lower voltage can be used to obtain a horizontal electric field intensity sufficient to achieve an object of liquid crystal alignment. For example, as shown in FIG. 4, in this embodiment, the height h is fixed to 10 μm, and the thickness t is fixed to under 0.5 μm, by changing values of the width w and the interval 1, a voltage-transmittance graph can be obtained, wherein:

when both the width w and the interval 1 are 10 μm, driving voltage is 3.51V and transmittance is 0.21;

when both the width w and the interval 1 are 7 μm, driving voltage is 2.88V and transmittance is 0.21;

when both the width w and the interval 1 are 4 μm, driving voltage is 2.31V and transmittance is 0.20;

it can be known that when the electrode unit 10 is used as each of the common electrodes 10a and each of the pixel electrode 10b, compared with the conventional in-plane-switching (IPS) often requiring a voltage of 4V-6V to be sufficient to achieve an object of liquid crystal alignment, the invention is indeed capable of reducing driving voltage and reducing power consumption.

Further, when a material used for the liquid crystal layer 23 is blue phase liquid crystal, a voltage-transmittance graph is as shown in FIG. 5, where variables of the height h and the thickness t are fixed under conditions as shown in FIG. 4:

when both the width w and the interval 1 are 10 μm, driving voltage is 28.5V and transmittance is 0.41;

when both the width w and the interval 1 are 7 μm, driving voltage is 19.5V and transmittance is 0.41;

when both the width w and the interval 1 are 4 μm, driving voltage is 11.5V and transmittance is 0.42;

compared with the conventional blue-phase liquid crystal driving voltage as high as 35V to 40V, reduction effect that the second preferred embodiment is capable of achieving has reached a significant level.

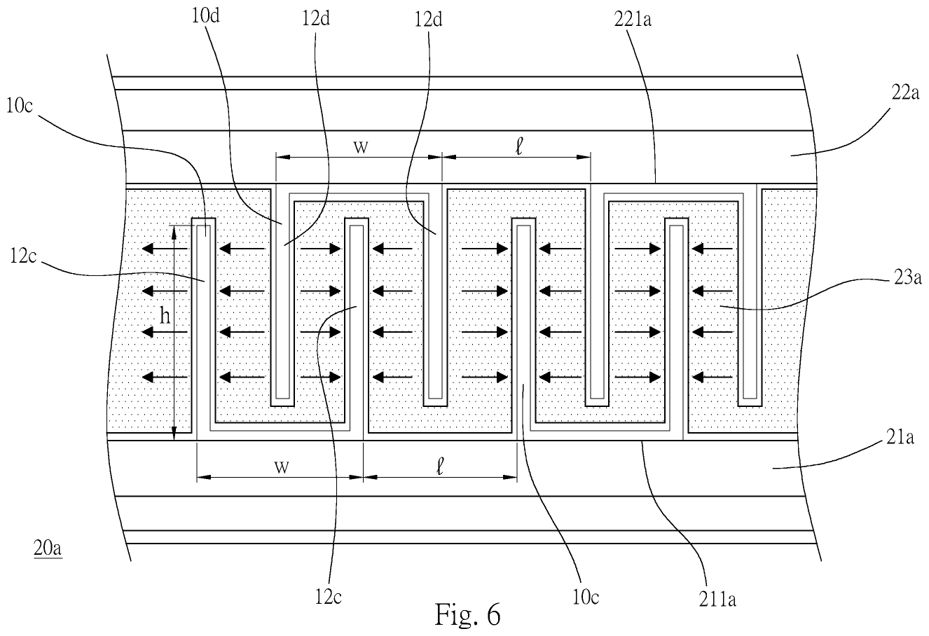

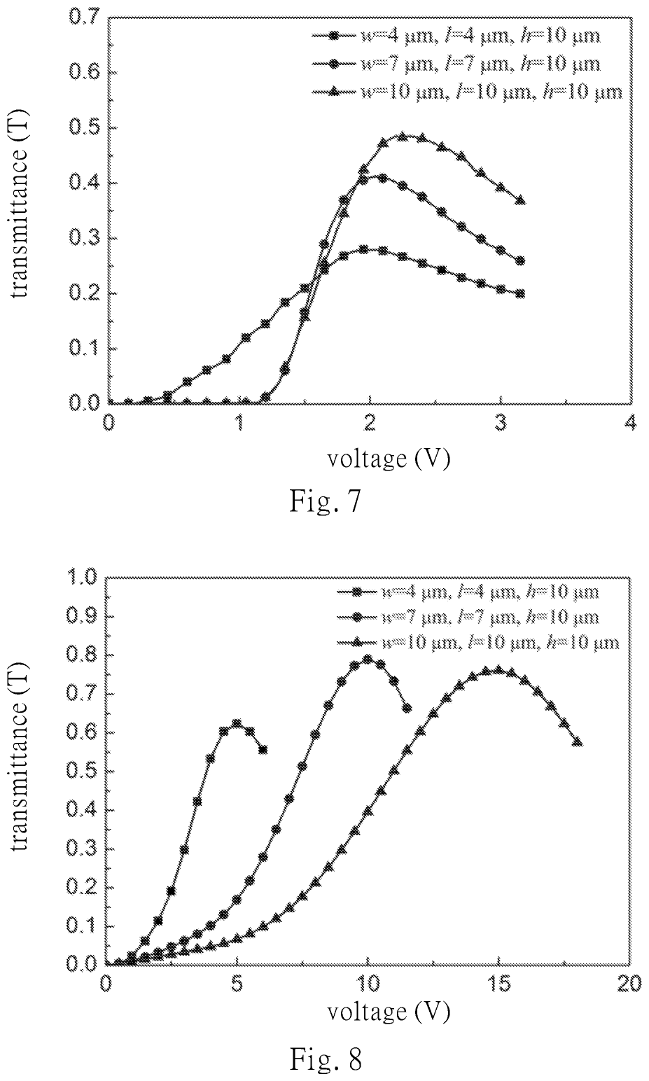

Please continue to refer to a third preferred embodiment of the invention shown in FIG. 6, where the electrode unit provided by the first preferred embodiment is used as common electrodes 10c and pixel electrodes 10d of a liquid crystal element 20a similar to the second preferred embodiment.

Wherein constitution of the liquid crystal element 20a is similar to that disclosed in the second preferred embodiment, and comprises a first baseplate 21a and a second baseplate 22a that are separated from each other, and a liquid crystal layer 23a sealed in a gap space of about 1 μm to 25 μm between the first baseplate 21a and the second baseplate 22a, wherein, when the liquid crystal layer 23a is positive type liquid crystal, a voltage-transmittance graph is as shown in FIG. 7, and when the liquid crystal layer 23a is blue phase liquid crystal, a voltage-transmittance graph is as shown in FIG. 8.

Each of the electrode units is respectively disposed on a side plane 211a of the first baseplate 21a facing the second baseplate 22a, and on a side plane 221a of the second baseplate 22a facing the first baseplate 21a. The electrode units disposed on the first baseplate 21a are respectively served as the common electrode 10c, and the electrode units disposed on the second baseplate 22a are respectively served as the pixel electrode 10d. Wherein the interval 1 spaced between the adjacent pixel electrodes 10d is the same as the interval 1 spaced between the adjacent common electrodes 10c, for each pair of the pixel electrode 10d and the common electrode 10c adjacent to each other, a side portion 12d of the pixel electrode 10d and a side portion 12c of the common electrode 10c are inserted into a U-shaped opening of each other in a staggered manner, so that the side portion 12d of each of the pixel electrodes 10d and the side portions 12c of each of the common electrodes 10c alternately correspond to each other sequentially.

The third preferred embodiment is capable of greatly increasing an intensity of the horizontal electric field E formed by an alternate spatial pattern of the side portions 12c, 12d, and compared with the technical content disclosed in the second preferred embodiment, a driving voltage of liquid crystal alignment can be further reduced, and a transmittance can also be further improved.

Please refer to FIG. 7, when a liquid crystal material used in the liquid crystal layer 23a in the third preferred embodiment is positive liquid crystal, and under conditions of the height h being set to 10 μm and the thickness t being set to 0.5 μm:

when the width w is 10 μm and the interval 1 is 10 μm, driving voltage is 2.20V and transmittance is 0.48;

when the width w is 7 μm and the interval 1 is 7 μm, driving voltage is 2.05V and transmittance is 0.41;

when the width w is 4 μm and the interval 1 is 4 μm, driving voltage is 1.95V and transmittance is 0.28;

obviously, it is indeed sufficient to further reduce a driving voltage compared to the second preferred embodiment.

Please refer to FIG. 8. When a liquid crystal material used in the liquid crystal layer 23a in the third preferred embodiment is blue phase liquid crystal material, and under conditions of the height h being set to 10 μm and the thickness t being set to 0.5 μm:

when the width w is 10 μm and the interval 1 is 10 μm, driving voltage is 15V and transmittance is 0.76;

when the width w is 7 μm and the interval 1 is 7 μm, driving voltage is 10V and transmittance is 0.78;

when the width w is 4 μm and the interval 1 is 4 μm, driving voltage is 5V and transmittance is 0.78;

these effects of significantly reducing a driving voltage of blue phase liquid crystal are sufficient to completely overcome the drawback of excessively high driving voltage of the conventional blue phase liquid crystal, so that the invention can be further widely applied in different industrial fields.

In summary, when the U-shaped coplanar electrode unit provided by the invention is applied to be used as an electrode element of a liquid crystal element, a significant degree of driving voltage reduction achieved has been confirmed to be capable of greatly increasing an intensity of horizontal electric field, using positive type liquid crystal as an example, within ranges of the previously disclosed embodiments, optimum parameters thereof are capable of obtaining a transmittance of 0.41 with a driving voltage of 1.95V; compared with the conventional FFS technology with a driving voltage of 4.1V only capable of achieving a transmittance of 0.24, the invention has achieved remarkable efficacies. In the alignment driving technology of blue phase liquid crystal, within ranges of the previously disclosed embodiments, optimum parameters thereof are capable of obtaining a transmittance of 0.63 with a driving voltage of only 5V; compared with the conventional technology with a driving voltage as high as 35V to be sufficient to drive blue phase liquid crystal for alignment, the invention is indeed capable of significantly reducing a driving voltage of blue phase liquid crystal, so that application of blue phase liquid crystal can be further expanded.

Herein, it is necessary to make a special explanation. Although applications of the second and third preferred embodiments in the first preferred embodiment is exemplified by liquid crystal display technology, the electrode unit disclosed in the first preferred embodiment is not limited to be only applied in liquid crystal display technology. In other words, the U-shaped coplanar electrode unit provided by the invention can be applied to be used not only as constitution of a liquid crystal element, but can also be used as an electrode for other objects, such as light-emitting element, solar cell element, driving element, control element, sensing element, detection element, capacitive element, mass transfer element, metamaterial element, thermoelectric element, heat dissipation element, optical element, or other functional components, it is not necessary to limit by usages or applications.

Furthermore, a shape of the U-shaped unit provided by the invention is not limited to those disclosed in the above embodiments. For example, when each of the side portions extends outward from the two sides of the base in a same direction, each of the side portions further extends laterally and connects to each other in a ring shape, so that after each of the side portions extends, a cross-section formed together with the base is in a cylindrical U-shape. In addition, the base can further comprise two base bodies, and each of the side portions extends outward in a same direction from one end of each of the base bodies opposite to each other, so that in the U-shape commonly formed by each of the side portions and the base, the U-shaped closed end formed by the base is commonly formed by the separated base bodies, so that the U-shape is a discontinuous shape with the closed end being disconnected.

It is to be understood that the above description is only preferred embodiments of the present invention and is not used to limit the present invention, and changes in accordance with the concepts of the present invention may be made without departing from the spirit of the present invention, for example, the equivalent effects produced by various transformations, variations, modifications and applications made to the configurations or arrangements shall still fall within the scope covered by the appended claims of the present invention.

What is claimed is:

1. A U-shaped unit comprising:
a base having a predetermined width; and
two side portions respectively extending outward from two sides of the base in a same direction, and forming a U-shaped cross-section commonly with the base, and a ratio between a thickness and a height of each of the side portions being between 1:20 and 1:2.

2. The U-shaped unit as claimed in claim 1, wherein an included angle between each of the side portions and the base is between 45 degrees and 135 degrees.

3. The U-shaped unit as claimed in claim 1, being made of transparent conductive material, metal material, dielectric material or semiconductor material.

4. The U-shaped unit as claimed in claim 1, wherein the base further comprises two separated base bodies, and each of the side portions respectively extends outward in a same direction from one end of each of the base bodies opposite to each other, thereby each of the base bodies causes the formed U-shape being a discontinuous shape.

5. The U-shaped unit as claimed in claim 1, wherein each of the side portions connects to each other in a ring shape.

6. The U-shaped unit as claimed in claim 1, being a unit of an electrode element, a unit of a heat dissipation element, or a unit of an optical element.

7. The U-shaped unit as claimed in claim 2, being a unit of an electrode element, a unit of a heat dissipation element, or a unit of an optical element.

8. The U-shaped unit as claimed in claim 3, being a unit of an electrode element, a unit of a heat dissipation element, or a unit of an optical element.

9. The U-shaped unit as claimed in claim 4, being a unit of an electrode element, a unit of a heat dissipation element, or a unit of an optical element.

10. The U-shaped unit as claimed in claim 5, being a unit of an electrode element, a unit of a heat dissipation element, or a unit of an optical element.

11. A liquid crystal element with U-shaped coplanar electrode units comprising:
a first baseplate;
a second baseplate separated from the first baseplate; and
a liquid crystal layer sealed between the first baseplate and the second baseplate;
the U-shaped coplanar electrode units being respectively the U-shaped unit served as the electrode unit as claimed in claim 6, and being located on one side of the first baseplate facing the second baseplate, each of the side portions extending into the liquid crystal layer, and making a height of each of the side portions greater than half of a distance between the first baseplate and the second baseplate.

12. The liquid crystal element with the U-shaped coplanar electrode units as claimed in claim 11, wherein the adjacent U-shaped coplanar electrode units are separated from each other by a distance between 3 nm and 20 μm.

13. The liquid crystal element with the U-shaped coplanar electrode units as claimed in claim 11, wherein each of the U-shaped coplanar electrode units is further provided on one side of the second baseplate facing the first baseplate, and each of the U-shaped coplanar electrode units located on the first baseplate and each of the U-shaped coplanar electrode units located on the second baseplate face each other with a U-shaped opening portion, and the single side portion of each of the U-shaped coplanar electrode units on the first baseplate and the single side portion of each of the U-shaped coplanar electrode units on the second baseplate are inserted into the U-shaped opening of each other.

14. The liquid crystal element with the U-shaped coplanar electrode units as claimed in claim 13, wherein an interval between the adjacent U-shaped coplanar electrode units located on the first baseplate is equal to an interval between the adjacent U-shaped coplanar electrode units located on the second baseplate.
